(19) United States
(12) Patent Application Publication
(10) Pub. No.: US 2023/0035357 A1
(43) Pub. Date: Feb. 2, 2023

(54) PRINTED BATTERY, RFID TAG, AND PRODUCTION METHOD

(71) Applicants: VARTA Microbattery GmbH, Ellwangen Jagst (DE); Elmeric GmbH, Rangendingen (DE)

(72) Inventors: Werner Fink, Rangendingen (DE); Martin Krebs, Rosenberg (DE); Sabrina Lang, Ammerbuch (DE)

(21) Appl. No.: 17/788,505

(22) PCT Filed: Dec. 23, 2020
(86) PCT No.: PCT/EP2020/087832

§ 371 Date: Jun. 23, 2022

(30) Foreign Application Priority Data
Dec. 23, 2019 (EP) 19219567.5

(51) Int. Cl. H01M 6/40; H01M 4/42; H01M 4/50; H01M 4/54; H01M 6/04; G06K 19/07

(52) U.S. Cl. CPC H01M 6/40; G06K 19/0702; G06K 19/0723; H01M 4/42; H01M 4/50; H01M 4/54; H01M 6/045; H01M 2004/027; H01M 2220/30

(57) ABSTRACT

A printed battery that supplies a transmission and/or reception unit of an RFID tag with an electrical current of at peak ≥ 400 mA includes a layer stack having an anode configured as a layer that contains particulate metallic zinc or a particulate metallic zinc alloy as an active electrode material and a first resilient binder or binder mixture, and a cathode configured as a layer that contains a particulate metal oxide as an active electrode material, at least one conductivity additive to control the electrical conductivity of the cathode, and a second resilient binder or binder mixture, and a separator configured as a layer that electrically insulates the anode and the cathode from one another, a first electrical conductor in direct contact with the anode, and a second electrical conductor in direct contact with the cathode, and a housing that encloses the layer stack.

### TECHNICAL FIELD

This disclosure relates to a printed battery and an RFID tag supplied with electrical current by the battery, and a method of producing the battery.

### BACKGROUND

RFID tags may be used to track all types of products, for example, pharmaceuticals and agricultural pesticides. Such RFID tags are described, for example, in WO 2019/145224 A1. They generally comprise an energy supply unit, at least one sensor, a control unit, a data memory in which a unique product identifier is stored, and a transmission and/or reception unit. With the aid of the sensor, it is possible to determine status information relating to the product, for example, relating to the opening status of its packaging. The control unit may then cause the transmission and/or reception unit to send the status information and the product identifier to a data receiver. Ideally, the energy supply unit should be able to deliver the energy required therefor over a period of several months, when at least 50 incoming and outgoing data transmissions should be possible during this period.

The transmission and/or reception unit may in principle be any data transmission device, data transmissions according to the Wi-Fi standard (IEEE 802.11) and the Bluetooth standard (IEEE 802.15.1) being, for example, possible. To ensure worldwide tracking of products, however, it is expedient to use mobile radio networks or other existing radio networks for the data transmission.

Mobile radio networks currently cover large parts of the inhabited world, and they are therefore particularly well-suited for the worldwide tracking of products. Mobile radio chips, however, still impose demanding requirements in respect of their energy consumption. This also applies for new-generation mobile radio chips which transmit according to the LTE standard (LTE = Long Term Evolution). Depending on the transmission protocol selected, peak currents of up to 400 mA need to be provided, at least for short time windows.

For universal use, RFID tags and therefore also their energy supply units must be as small and economical to produce as possible. Furthermore, environmental friendliness and safety are important parameters for all products in mass use. Inter alia, for these reasons printed batteries in WO 2019/145224 A1 are taken into consideration as energy supply units.

The hitherto known printed batteries, however, do not satisfy the requirements outlined above, or at best satisfy them only partially. For example, the batteries described in U.S. 2010/081049 A1 are not capable of delivering a peak current of the aforementioned order of magnitude. All lithium-based systems are ruled out for safety reasons because of their combustible electrolyte. Nickel-metal hydride batteries are problematic for reasons of printing technology.

It could therefore be helpful to provide an energy supply unit adapted particularly to supply the transmission and/or reception units of RFID tags, in particular also for transmission and/or reception units which operate according to the LTE standard.

### SUMMARY

We provide a printed battery that supplies a transmission and/or reception unit of an RFID tag with an electrical current of at peak ≥ 400 mA, including a) a layer stack having an anode configured as a layer that contains particulate metallic zinc or a particulate metallic zinc alloy as an active electrode material and a first resilient binder or binder mixture, and a cathode configured as a layer that contains a particulate metal oxide as an active electrode material, at least one conductivity additive to control the electrical conductivity of the cathode, and a second resilient binder or binder mixture, and a separator configured as a layer that electrically insulates the anode and the cathode from one another, b) a first electrical conductor in direct contact with the anode, and a second electrical conductor in direct contact with the cathode, and c) a housing that encloses the layer stack, wherein d) the separator is arranged between the anode and the cathode and includes a first side and a second side, of which the first side includes a first contact face for the anode and the second side parallel thereto includes a second contact face for the cathode, and e) the contact faces overlap one another, in a viewing direction perpendicular to the separator configured as a layer, in an overlap region A in which a straight line perpendicular to the separator intersects the two contact faces, f) the cathode contains the particulate metal oxide in a proportion of 10 wt% to 90 wt%, expressed in terms of the total weight of the solid constituents of the cathode (102), g) the cathode contains the second resilient binder or binder mixture in a proportion of 1 wt% to 25 wt%, expressed in terms of the total weight of the solid constituents of the cathode, h) the cathode contains the at least one conductivity additive in a proportion of 2.5 wt% to 35 wt%, expressed in terms of the total weight of the solid constituents of the cathode (102), and i) an overlap region A of the battery has a minimum size of 17.3 cm².

We also provide an RFID tag including, on a carrier, a transmission and/or reception unit that transmits and/or receives radio signals and a printed battery arranged on the carrier that supplies the transmission and/or reception unit with an electrical current of at peak ≥ 400 mA, wherein the battery is configured as a printed battery that supplies a transmission and/or reception unit of an RFID tag with an electrical current of at peak ≥ 400 mA, including a) a layer stack having an anode configured as a layer that contains particulate metallic zinc or a particulate metallic zinc alloy as an active electrode material and a first resilient binder or binder mixture, and a cathode configured as a layer that contains a particulate metal oxide as an active electrode material, at least one conductivity additive to control the electrical conductivity of the cathode, and a second resilient binder or binder mixture, and a separator configured as a layer that electrically insulates the anode and the cathode from one another, b) a first electrical conductor in direct contact with the anode, and a second electrical conductor in direct contact with the cathode, and c) a housing that encloses the layer stack, wherein d) the separator is arranged between the anode and the cathode and includes a first side and a second side, of which the first side includes a first contact face for the anode and the second side parallel thereto includes a second contact face for the cathode, and e) the contact faces overlap one another, in a viewing direction perpendicular to the separator configured as a layer, in an overlap region A in which a straight line perpendicular to the separator intersects the two contact faces, f) the cathode contains the particulate metal oxide in a proportion of 10 wt% to 90 wt%, expressed in terms of the total weight of the solid constituents of the cathode (102), g) the cathode contains the second resilient binder or binder mixture in a proportion of 1 wt% to 25 wt%, expressed in terms of the total weight of the solid constituents of the cathode, h) the cathode contains the at least one conductivity additive in a proportion of 2.5 wt% to 35 wt%, expressed in terms of the total weight of the solid constituents of the cathode (102), and i) an overlap region A of the battery has a minimum size of 17.3 cm².

We further provide a method of producing a printed battery that supplies a transmission and/or reception unit of an RFID tag with an electrical current of at peak ≥ 400 mA, including a) printing a first electrical conductor onto an electrically nonconductive carrier and a second electrical conductor onto an electrically nonconductive carrier, b) printing an anode as a layer directly onto the first electrical conductor, a printing paste that contains particulate metallic zinc or a particulate metallic zinc alloy and a first resilient binder or binder mixture being used, c) printing a cathode as a layer directly onto the second electrical conductor, a printing paste that contains a particulate metal oxide, at least one conductivity additive for controlling the electrical conductivity of the cathode and a second resilient binder or binder mixture being used, wherein the printing paste contains the particulate metal oxide in a proportion of 10 wt% to 90 wt%, expressed in terms of the total weight of its solid constituents, the printing paste contains the second resilient binder or binder mixture in a proportion of 1 wt% to 15 wt%, expressed in terms of the total weight of its solid constituents, and the printing paste contains the at least one conductivity additive in a proportion of 2.5 wt% to 35 wt%, expressed in terms of the total weight of its solid constituents, d) printing or applying a separator, configured as a layer, onto the anode and/or the cathode, and e) forming a layer stack consisting of the sequence anode/separator/cathode, in which the separator is arranged between the anode and the cathode and includes a first side and a second side, of which the first side includes a first contact face for the anode and the second side parallel thereto includes a second contact face for the cathode, the contact faces overlap one another, in a viewing direction perpendicular to the separator configured as a layer, in an overlap region A in which a straight line perpendicular to the separator intersects the two contact faces, and the overlap region A has a minimum size of 17.3 cm².

### BRIEF DESCRIPTION OF THE DRAWINGS

FIGS. 1A - 1F, respectively, schematically illustrate a procedure according to the example with each of steps (1) - (6) in a plan view directly from above.

FIG. 2 schematically illustrates a cross section through the battery formed according to the procedure represented in FIGS. 1A - 1F.

FIG. 3 schematically illustrates an RFID tag with the battery represented in FIG. 2 (plan view from above).

FIGS. 4A and 4B schematically illustrate two examples of a layer stack of a battery (plan view vertically from above) with overlap regions of different sizes.

FIG. 5 schematically illustrates the result of a pulse test with a battery.

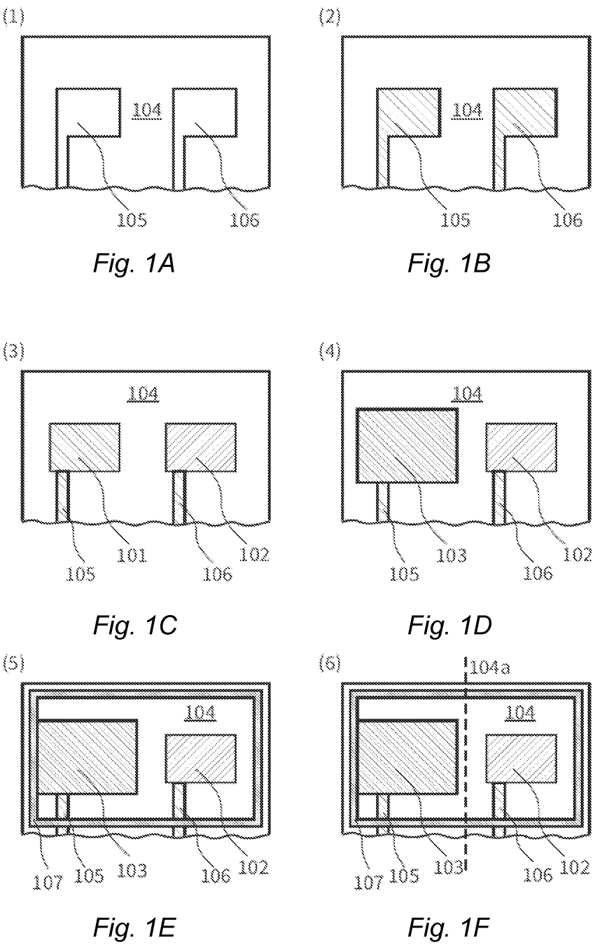

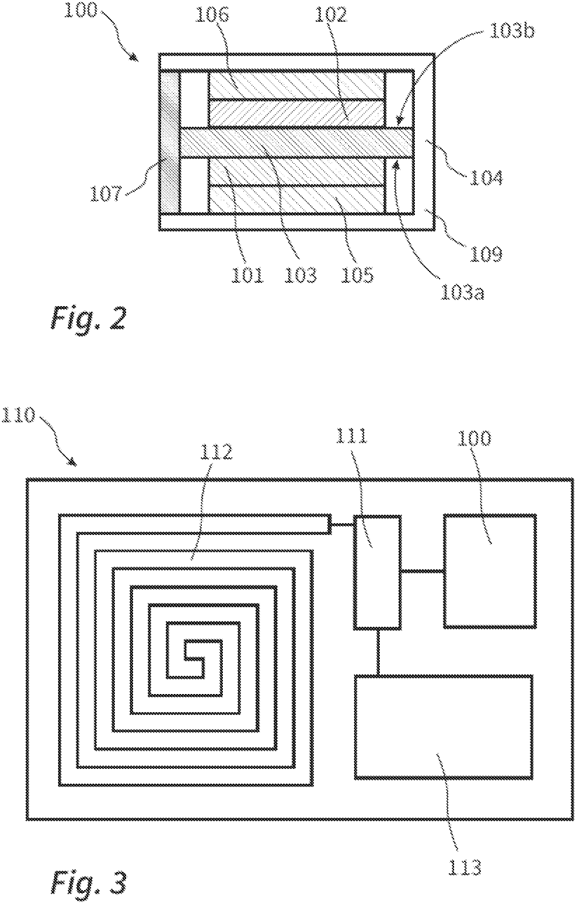

### DETAILED DESCRIPTION

The term “battery” originally meant a plurality of electrochemical cells connected in series. Nowadays, however, the term “battery” is used more widely and often also includes individual electrochemical cells (individual cells). This is within the scope of this disclosure. The battery may thus be either an individual cell having only one anode and one cathode or a combination of a plurality of electrochemical cells.

The printed battery is preferably used to supply a transmission and/or reception unit with an electrical current of at peak ≥ 400 mA. It may therefore inter alia supply electrical energy to mobile radio chips operating according to the LTE standard. In principle, however, it is also suitable for other applications.

The battery comprises features a. to e.:
a. a layer stack having
   an anode configured as a layer that contains, preferably in a homogeneous mixture, particulate metallic zinc or a particulate metallic zinc alloy as an active electrode material and a first resilient binder or binder mixture,
   a cathode configured as a layer that contains, preferably in a homogeneous mixture, a particulate metal oxide as an active electrode material, at least one conductivity additive for controlling the electrical conductivity of the cathode, and a second resilient binder or binder mixture, and
   a separator configured as a layer that electrically insulates the anode and the cathode from one another, and
b. a first electrical conductor in direct contact with the anode, and a second electrical conductor in direct contact with the cathode, and
c. a housing that encloses the layer stack, wherein
d. the separator is arranged between the anode and the cathode and comprises a first side and a second side, of which the first side comprises a first contact face for the anode and the second side parallel thereto comprises a second contact face for the cathode, and
e. the contact faces overlap one another, in a viewing direction perpendicular to the separator configured as a layer, in an overlap region A in which a straight line perpendicular to the separator intersects the two contact faces.

A printed battery in this example means a battery in which at least the electrodes, and optionally the electrical conductors, and in some preferred examples the separator and optionally further functional parts, are formed by printing a printing paste onto a carrier, in particular by a screen printing method. In the battery, at least the anode containing zinc and the cathode containing metal oxide are thus printed. Preferably, the electrodes and the electrical conductors, in particular the first and second electrical conductors, are printed.

The anode and the cathode preferably each have a thickness of 10 µm to 350 µm, preferably up to 250 µm. The cathode is often configured to be somewhat thicker than the anode since the latter has a higher energy density in many instances. In some applications, it may thus be preferable to form the anode as a layer with a thickness of 30 µm to 150 µm and the cathode as a layer with a thickness of 180 to 350 µm. The capacitances of the anode and the cathode may be balanced by adjusting the thicknesses. It is preferable in this regard for the cathode to be overdimensioned in relation to the anode.

The selection of an electrochemical system with an anode containing zinc is above all due to the required safety. Systems with zinc-based anodes require an aqueous electrolyte and are therefore noncombustible. Furthermore, zinc is environmentally friendly and inexpensive.

The stacked arrangement of the electrodes and the separator has proven superior to a coplanar arrangement, as in the electrodes of the cell described in U.S. 2010/081049 A1. The current carrying capacity of cells having stacked electrodes is significantly higher since the ions that migrate to and fro between the electrodes during charging and discharging processes need to travel much shorter paths on average. Inside the overlap region, the shortest distance between the electrodes corresponds to the thickness of the separator arranged between the anode and the cathode.

With an identical size and a non-offset arrangement of the anode and the cathode within a stack, the size of the overlap region corresponds exactly to the size of the electrodes.

The stacked arrangement per se, however, is still not sufficient to impart the required current carrying capacity to the battery with the anode containing zinc. Rather, for this purpose the battery is distinguished by a combination of the following additional features f. to h.:
f. the cathode contains the particulate metal oxide in a proportion of 10 wt% to 90 wt%, expressed in terms of the total weight of the solid constituents of the cathode,
g. the cathode contains the second resilient binder or binder mixture in a proportion of 1 wt% to 25 wt%, expressed in terms of the total weight of the solid constituents of the cathode, and
h. the cathode contains the at least one conductivity additive in a proportion of 1 wt% to 85 wt%, expressed in terms of the total weight of the solid constituents of the cathode.

The battery may comprise a single layer stack having the anode configured as a layer, the cathode configured as a layer and the separator configured as a layer. It may, however, comprise two or more such layer stacks, in particular two or more identical layer stacks having the aforementioned features a. and d. to h.

The battery also has features a. and b., and optionally c.:
a. the battery comprises a first layer stack having the aforementioned features a. and d. to h;
b. the battery comprises a second layer stack having the aforementioned features a. and d. to h; and
c. optionally, the battery comprises n further layer stacks having the aforementioned features a. and d. to h., where n is preferably an integer of from 1 to 100, preferably from 1 to 10.

The housing in this example preferably encloses all the layer stacks. Furthermore, the battery in this example preferably comprises a first and a second electrical conductor respectively for the anodes and cathodes of each individual one of the layer stacks.

Particularly preferably, the battery is furthermore distinguished by feature i:

i. the overlap region A of the battery has a minimum size of 17.3 cm².

When the battery comprises precisely one layer stack, the minimum size of 17.3 cm² refers to the overlap region in the one layer stack. When the battery comprises two or more of the layer stacks, the overlap region A of the battery corresponds to the sum of the overlap regions in the two or more layer stacks. The total size of the overlap regions should thus preferably be at least 17.3 cm².

Particularly preferably, the battery comprises two or more layer stacks, each of which is distinguished by an overlap region having a minimum size of 17.3 cm².

To impart the required current carrying capacity to the battery, the overlap region thus has a defined minimum size. How large this must be is in turn related in particular to the composition of the cathode or the cathodes. The components thereof, the particulate metal oxide, the second resilient binder or binder mixture and the at least one conductivity additive, must be contained in the cathode or the cathodes within established proportion ranges.

The overlap region of the battery preferably has a maximum size of 500 cm², particularly preferably 100 cm².

In configurations with a plurality of layer stacks, it is preferred for the layer stacks that form functional electrochemical cells independently of one another to be interconnected with one another electrically in series and/or in parallel. The current carrying capacity of the battery can also be increased in this way so that it can provide the required powers.

In particular, series electrical interconnection of the layer stacks contained by the battery is preferred for this. For this purpose, the battery may have additional conductors which electrically connect the anodes and cathodes of different layer stacks to one another, or anodes and cathodes to be interconnected are connected to one another by a common electrical conductor. Batteries having four or more layer stacks interconnected in series are particularly suitable for supplying electrical energy to mobile radio chips operating according to the LTE standard, in particular when each of the layer stacks is distinguished by an overlap region with the minimum size of 17.3 cm².

In some examples, however, parallel electrical interconnection of the layer stacks which the battery comprises is preferred.

In principle, all percentage specifications for proportions by weight of components in electrodes are expressed in terms of the total weight of the solid constituents of the respective electrode. The proportions by weight of the components respectively involved in this example add up to 100 wt%. Before they are determined, moisture contained in the electrodes may need to be removed.

The proportion of the second resilient binder or binder mixture must be at least 1 wt% since it is intended to fix the metal oxide particles contained in the cathode or cathodes relative to one another and at the same time impart a certain flexibility to the cathode or cathodes. The proportion must not, however, exceed the maximum proportion mentioned above since otherwise the risk arises that the metal oxide particles will at least partially no longer be in contact with one another. Within the range mentioned above, a proportion of 1 wt% to 15 wt%, particularly preferably in a proportion of 5 wt% to 15 wt%, is more preferred.

The proportions of the particulate metal oxide and the at least one conductivity additive are mutually dependent. The closer the proportion of the at least one conductivity additive comes to the lower limit mentioned, the higher the proportion of the particulate metal oxide preferably is. The same applies vice versa.

Within the range mentioned above for the particulate metal oxide, a proportion of 50 wt% to 90 wt% is more preferred.

Within the range mentioned above for the at least one conductivity additive, a proportion of 2.5 wt% to 35 wt% is more preferred.

Furthermore, the size of the overlap region A and the total proportion G of the particulate metal oxide and of the at least one conductivity additive in the cathode or cathodes are preferably also mutually dependent. The closer the size of the overlap region comes to the lower limit mentioned, the higher the total proportion G preferably is. The same applies vice versa.

Preferably, the battery is distinguished by at least one of additional features a. to c.:
a. the total proportion G of the particulate metal oxide and of the at least one conductivity additive in the cathode is 0.85 to 0.95 times the total weight of the solid constituents of the cathode or cathodes;
b. the ratio of the proportion by weight of the particulate metal oxide to the proportion by weight of the at least one conductivity additive in the cathode or cathodes is 20:1 to 5:1; and
c. for the ratio of the size of the overlap region A [cm²] of the battery to the total proportion G, the following condition applies:
$$\text{x} \left[{\text{cm}}^{2}\right] ∗ 0.95 \underline{<} \text{A} \left[{\text{cm}}^{2}\right] ∗ \text{G} \text{.}$$

Particularly preferably, features a. to c. directly above are implemented in combination with one another.

A high proportion of the metal oxide in the cathode or cathodes increases the capacitance of the battery. For the current carrying capacity, however, the proportion of the at least one conductivity additive is of greater importance than the total proportion of the metal oxide.

As regards the selection of a suitable conductivity additive, two particularly preferred examples are available for selection in the scope of this disclosure.

In a first particularly preferred example, the battery is distinguished by at least one of additional features a. and b.:
a. the cathode or cathodes contain at least one carbon-based material as a conductivity additive, in particular from the group consisting of activated carbon, activated carbon fibers, carbide-derived carbon, carbon aerogel, graphite, graphene and carbon nanotubes (CNTs); and
b. the cathode or cathodes contain the at least one carbon-based material in a proportion of 25 wt% to 35 wt% (see above).

Particularly preferably, features a. and b. directly above are implemented in combination with one another.

This example uses the fact that the conductivity additives specified not only increase the electrical conductivity of the cathode or cathodes, but they can also impart a double-layer capacitance to the cathode or cathodes in addition to their Faradaic capacitance. Very high currents may therefore be provided for short periods of time.

Surprisingly, we found that a similarly positive effect may be achieved by adding conducting salts, which can crystallize in the cathode when the cathode dries, to the cathode or cathodes during their production via the electrode paste. During subsequent printing of the electrolyte, the crystalline conducting salts can be wetted very rapidly and can lead to better permeation of the electrodes with an ion-conducting liquid.

Correspondingly, in a second particularly preferred example, the battery is distinguished by at least one of additional features a. and b.:
a. the cathode or cathodes contain at least one water-soluble salt as a conductivity additive; and
b. the cathode or cathodes contain the at least one water-soluble salt in a proportion of 1 wt% to 25 wt%.

Particularly preferably, features a. and b. directly above are implemented in combination with one another.

As a water-soluble salt, halides in particular may be added to the cathode or cathodes for the purpose of improving the electrical conductivity, preferably chlorides, in particular zinc chloride and/or ammonium chloride.

In some preferred examples, the structures mentioned may also be combined. In these examples, the battery is distinguished by a combination of the following features a. and b.:
a. the cathode or cathodes contain the at least one carbon-based material as a first conductivity additive, in particular from the group consisting of activated carbon, activated carbon fibers, carbide-derived carbon, carbon aerogel, graphite, graphene and carbon nanotubes (CNTs); and
b. the cathode or cathodes contain the at least one water-soluble salt as a second conductivity additive.

In preferred examples, the battery is distinguished by one of features a. and b.:
a. the cathode or cathodes contain manganese oxide as a particulate metal oxide; and
b. the cathode or cathodes contain silver oxide as a particulate metal oxide.

The battery is thus preferably a zinc/manganese oxide battery or a zinc/silver oxide battery.

In other preferred examples, the battery is distinguished by at least one of additional features a. to c.:
a. the anode or anodes contain as a first resilient binder or binder mixture at least one member of the group consisting of cellulose and derivatives thereof, in particular carboxymethyl cellulose (CMC), polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR) and mixtures of the aforementioned materials;
b. the cathode or cathodes contain as a second resilient binder or binder mixture at least one member of the group consisting of cellulose and derivatives thereof, in particular carboxymethyl cellulose (CMC), polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR) and mixtures of the aforementioned materials; and
c. the first and the second resilient binder or binder mixture are materially identical.

Particularly preferably, features a. and b. directly above are implemented in combination with one another. In some refinements of these particularly preferred examples, features a. to c. directly above are implemented in combination with one another.

Particularly preferably, a combination of a polysaccharide suitable as an electrode binder, in particular a cellulose derivative, and SBR are contained as a binder or binder mixture both in the cathode or cathodes and in the anode or anodes. For example, the anode or anodes and the cathode or cathodes may contain 0.5 wt% to 2.5 wt% carboxymethyl cellulose and/or chitosan and 5 wt% to 10 wt% SBR. The cellulose derivative or the chitosan are used here as an emulsifier. They assist the distribution of the resilient binder (SBR) in the paste.

The anode or anodes of the battery contain the first resilient binder or binder mixture in a proportion of 1 wt% to 25 wt%, expressed in terms of the total weight of their solid constituents.

The anode or anodes preferably contain the particulate metallic zinc or the particulate metallic zinc alloy in a proportion of 40 wt% to 80 wt%.

Optionally, the anode or anodes may also contain a proportion of a conductivity additive. Since the active material of the anode or anodes is inherently electrically conductive already, however, this is not necessarily required.

In one particularly preferred example, the battery is distinguished by the combination of the four additional features a. to d.:
a. the cathode or cathodes contain a metal oxide from the group consisting of manganese oxide and silver oxide as a particulate metal oxide;
b. the cathode or cathodes contain at least one water-soluble salt as a conductivity additive;
c. the cathode or cathodes contain the at least one water-soluble salt in a proportion of 1 wt% to 25 wt%; and
d. the cathode or cathodes contain a combination of carboxymethyl cellulose and SBR as a second resilient binder or binder mixture.

It has already been mentioned in the introduction that, in some examples, the separator may also be printed. Suitable printing pastes for this may be found, for example, in EP 2 561 564 B1.

In other example, however, the separator may also be a porous sheet material, for example, a porous film or a nonwoven, arranged between the anode and the cathode. Suitable sheet materials and corresponding procedures are described in EP 3 477 727 A1.

Particularly preferably, a nonwoven or a microporous plastic film with a thickness of 60 to 120 µm and a porosity (ratio of the hollow volume to the total volume) of 35 - 60% is used. The nonwoven or the film preferably consists of a polyolefin, for example, polyethylene.

Not least, it is possible for a solid electrolyte such as is described, for example, in a preferred example in EP 2 960 967 B1, to be arranged between the electrolytes, although variants in which a liquid electrolyte is used are preferred in many instances.

Accordingly, the layer stack or stacks of the battery are preferably distinguished by at least one of additional features a. and b.:
a. they comprise an aqueous electrolyte which contains a chloride-based conducting salt; and
b. the separator which is arranged between the anode and the cathode is impregnated with the electrolyte.

Particularly preferably, features a. and b. directly above are implemented in combination with one another.

In particular, zinc chloride and ammonium chloride are suitable as a chloride-based conducting salt. It is preferred for the pH of the aqueous electrolyte to vary in the neutral or slightly acidic range.

Particularly preferably, the aqueous electrolyte contains an additive to increase the viscosity (set-up agent) and/or mineral filler particles, particularly in an amount such that the electrolyte has a paste-like consistency. Such an electrolyte will also be referred to below as an electrolyte paste.

In particular, silicon dioxide is suitable as a set-up agent. However, binding substances such as carboxymethyl cellulose may also be used to increase the viscosity.

For example, ceramic solids, salts which are almost or entirely insoluble in water, glass and basalt and carbon are suitable as mineral filler particles. The term “ceramic solids” in this example covers all solids that can be used to produce ceramic products, including silicate materials such as aluminosilicates, glasses and clay minerals, oxidic raw materials such as titanium dioxide and aluminum oxide, as well as non-oxidic materials such as silicon carbide or silicon nitride.

The term “almost or entirely insoluble” means that there is at most a low solubility, preferably even no solubility, in water at room temperature. The solubility of the mineral filler particles, in particular the aforementioned salts which are almost or entirely insoluble in water, should for this purpose ideally not exceed the solubility of calcium carbonate in water at room temperature. Calcium carbonate is moreover a particularly preferred example of an inorganic solid which the electrolyte paste may contain as a particulate filler component.

Particularly preferably, the electrolyte paste has the following composition:

| | |
|---|---|
| chloride-based conducting salt | 30 to 40 wt% |
| set-up agent (e.g., SiOₓ powder) | 2 to 4 wt% |
| mineral particles (e.g., CaCO₃) | 10 to 20 wt% |
| solvent (preferably water) | 40 to 55 wt%. |

Zinc chloride and/or ammonium chloride is preferably also used here as a chloride-based conducting salt.

In another preferred example, the battery is distinguished by additional feature a.:

a. the battery comprises conductive tracks consisting of metal particles, in particular silver particles or particles of a silver alloy, as a first and/or second electrical conductor.

Printable conductive pastes with silver particles for producing the electrical conductors are readily available on the market.

The RFID tag comprises, on a carrier, a transmission and/or reception unit that transmits and/or receives radio signals and a printed battery arranged on the carrier to supply the transmission and/or reception unit with an electrical current of at peak ≥ 400 mA, the battery being configured as claimed in one of the preceding claims.

To measure a peak current deliverable by a battery, the impedance of the battery is preferably derived from the electrochemical impedance spectrum (EIS). In this measurement method, the impedances Z are determined as a function Z = Z(f) of the measurement frequency f. Loading by a pulsed current with a length of 1 s corresponds best to the impedance value Z(0.5 Hz). This is taken into account together with the voltage difference between open-circuit voltage and closed-circuit voltage of the electronic application according to Ohm’s law:

$$\text{peak current i = voltage difference} Δ \text{U} / \text{Z} \left(0.5 \text{Hz}\right) .$$

Preferably, the battery has been printed directly onto the carrier. It may, however, also be preferred to manufacture the battery separately and fix it on the carrier, for example, by an adhesive.

In respect of possible preferred configurations of the RFID tag, reference is hereby made to WO 2019/145224 A1. For example, this explicitly describes a sensor system that may be part of the RFID tag and with the aid of which status information relating to a product which is labeled with the RFID tag can be determined.

Above all, the carrier and the transmission and/or reception unit are of importance. The latter is preferably a mobile radio chip, as mentioned in the introduction, in particular a chip which handles data transmissions according to the LTE standard.

The carrier may be configured in almost any desired way. What is important is merely that the surface on which the conductors of the battery are printed does not have any electrically conductive properties to prevent short circuits or creepage currents. For example, the carrier may be a plastic-based tag, when a film of a polyolefin or of polyethylene terephthalate which has an adhesive face on one side by which it can be fixed on a product would, for example, be suitable. The electrical conductors of the battery and the other functional units thereof may be fitted on the other side.

Particularly preferably, the RFID tag can obtain electrical energy from the environment of the RFID tag. For this purpose, the RFID tag may be equipped with an energy transducer which is capable of converting energy from the environment into electrical energy. For example, the piezoelectric effect, the thermoelectric effect or the photoelectric effect may be used for the conversion. The energy from the environment may, for example, be provided in the form of light, electric fields, magnetic fields, electromagnetic fields, motion, pressure and/or heat and/or other forms of energy, and be used or “harvested” with the aid of the energy transducer.

Preferably, the energy transducer is coupled to the battery so that it can charge the latter. Although zinc/manganese oxide or zinc/silver oxide batteries are classed among so-called primary cells, which in principle are not intended for charging, recharging nevertheless still works to a limited extent with such batteries.

It has already been discussed that at least the most important functional parts of the battery are formed with the aid of a printing method, in particular by screen printing. The method is used to produce a battery as described above, and is distinguished by steps a. to e.:
a. printing a first electrical conductor onto an electrically nonconductive carrier and a second electrical conductor onto an electrically nonconductive carrier;
b. printing an anode as a layer directly onto the first electrical conductor, a printing paste that contains particulate metallic zinc or a particulate metallic zinc alloy and a first resilient binder or binder mixture being used;
c. printing a cathode as a layer directly onto the second electrical conductor, a printing paste that contains a particulate metal oxide, at least one conductivity additive that controls the electrical conductivity of the cathode and a second resilient binder or binder mixture being used, wherein
   the printing paste contains the particulate metal oxide in a proportion of 10 wt% to 90 wt%, expressed in terms of the total weight of its solid constituents, and
   the printing paste contains the second resilient binder or binder mixture in a proportion of 1 wt% to 25 wt%, preferably in a proportion of 1 wt% to 15 wt%, particularly preferably in a proportion of 5 wt% to 15 wt%, expressed in terms of the total weight of its solid constituents; and
   the printing paste contains the at least one conductivity additive in a proportion of 1 wt% to 85 wt%, preferably in a proportion of 2.5 wt% to 35 wt%, expressed in terms of the total weight of its solid constituents;
d. printing or applying a separator, configured as a layer, onto the anode and/or the cathode; and
e. forming a layer stack consisting of the sequence anode/separator/cathode, in which
   the separator is arranged between the anode and the cathode and comprises a first side and a second side, of which the first side comprises a first contact face for the anode and the second side parallel thereto comprises a second contact face for the cathode; and
   the contact faces overlap one another, in a viewing direction perpendicular to the separator configured as a layer, in an overlap region in which a straight line perpendicular to the separator intersects the two contact faces.

In producing a battery with two or more layer stacks, the aforementioned steps a. to e. may need to be carried out several times.

In each example, it is advantageous for the overlap region A of the battery to have the aforementioned minimum size of 17.3 cm². It is therefore preferred to dimension and position the electrodes of the layer stack or layer stacks and the separator or separators accordingly.

Preferred examples relating to the selection and proportions of the particulate metal oxide, of the particulate metallic zinc or of the particulate metallic zinc alloy, of the first and the second resilient binder or binder mixture and of the at least one conductivity additive to control the electrical conductivity have already been discussed in the description of the battery. The preferred examples described there also apply in connection with the described production method.

The same applies for the selection of the carrier and of the separator that have also already been specified in detail in the description of the battery.

Besides the respective solid constituents, the printing pastes preferably also contain a volatile solvent or suspending agent. Ideally, this is water.

So that there are no problems with the printing, the printing pastes preferably contain all particulate constituents with particle sizes of at most 50 µm .

In a subsequent step, the mobile radio chip may be fixed on the carrier, next to the battery. It may therefore also be expedient, during the printing of the electrical conductors for the battery, at the same time to print all other electrical connections to and from the mobile radio chip and optionally also an antenna coupled to the mobile radio chip.

Preferably, it is characterized by at least one of additional features and/or steps a. and b.:
a. manganese oxide is used as particulate metal oxide; and
b. the first and/or the second conductor are printed over with an electrically conductive carbon layer before the anode and the cathode are printed.

Particularly preferably, features a. and b. directly above are implemented in combination with one another.

The carbon layer is used to protect the first and/or second conductor or, in a plurality of layer stacks, the first conductors and the second conductors. Particularly when the first and/or second conductor comprise silver particles, the risk arises of silver dissolving in the electrolyte and weakening or even destruction of conductive tracks taking place. The carbon layer can protect the silver layer from direct contact with the electrolyte.

Preferably, the carbon layer is formed with a thickness of 5 µm to 30 µm, particularly 10 µm to 20 µm.

Preferably, the carbon layer is subjected to a heat treatment after the application. Its leaktightness may thereby be increased.

In another preferred example of the method, it is characterized by at least one of additional features and/or steps a. and b.:
a. before and/or after the printing or applying of the separator configured as a layer, the anode and the cathode are impregnated with a liquid electrolyte; and
b. before impregnation with the liquid electrolyte, a sealing frame that encloses the anode and the cathode is formed or arranged on the carrier.

Particularly preferably, features a. and b. directly above are implemented in combination with one another.

Preferred liquid electrolytes have already been referred to in the scope of the descripttion of the battery. If one of the water-soluble salts described above is used as the at least one conductivity additive, it may be sufficient merely for the electrode to which this salt has been added to be impregnated with water, since the liquid electrolyte is then formed automatically.

The sealing frame ensures that liquid applied onto the electrodes does not run on the carrier. Possible examples of the sealing frame and variants of its formation are known from EP 3 477 727 A1.

Preferably, the sealing frame is formed from an adhesive compound that can so to speak be applied with the aid of a printing method. In this example, any adhesive which is resistant to the electrolyte respectively used and can form a sufficient bond with the carrier may in principle be employed. In particular, the sealing frame may also be formed from a dissolved polymer composition, from which the solvent that it contains must be removed to solidify it.

It is also possible to form the sealing frame from a thermoactivatable film, in particular a hot-melt film, or a self-adhesive film.

In a first particularly preferred alternative example, the method is distinguished by features:
a. before applying the separator, a first layer of an electrolyte paste is printed either onto the anode or onto the cathode, in particular with a thickness of 30 to 70 µm;
b. the separator is applied onto the first layer of the electrolyte paste; and
c. after applying the separator, either a second layer of the electrolyte paste is printed onto the separator, in particular with a thickness of 30 to 70 µm.

In a second particularly preferred alternative example, the method is distinguished by features:
a. before applying the separator, a first layer of an electrolyte paste is printed onto the anode and a second layer of an electrolyte paste is printed onto the cathode, preferably each with a thickness of 30 to 70 µm;
b. the separator is applied onto the first or second layer of the electrolyte paste; and
c. the layer stack is formed such that the first layer of the electrolyte is arranged on one side of the separator and the second layer of the electrolyte is arranged on the other side of the separator.

In a layer stack configured in this way, one of the layers of the electrolyte paste is always arranged between the electrodes and the separator.

### Particularly Preferred Feature Combinations

To transmit an LTE message, a scan first takes place. In this exanple, the label searches for suitable frequencies for the data transmission. This process takes on average 2 s and requires 50 mA. When the frequency has been found, a so-called TX pulse is sent. Such a pulse lasts about 150 ms and requires an electrical current pulse of about 200 mA for this. A pulse with a length of 150 ms corresponds approximately to a frequency of 4 Hz. Accordingly, the impedance of the battery at 4 Hz is of importance for the transmission of such a pulse.

Particularly good results may be achieved in this context if the anode and cathode compositions as well as the composition of the electrolyte are matched to one another. Particularly preferably, the following paste compositions are used in combination to produce the anodes, cathodes and electrolyte layers of batteries:

Anode Paste

| | |
|---|---|
| zinc powder (mercury-free): | 65 - 79 wt% |
| emulsifier (e.g., CMC) | 1 - 5 wt% |
| binder, resilient (e.g., SBR) | 5 - 10 wt% |
| solvent (e.g., water) | 15 - 20 wt% |

Cathode Paste

| | |
|---|---|
| manganese dioxide | 50 - 70 wt% |
| conductive material (e.g., graphite, carbon black) | 5 - 8 wt% |
| emulsifier (e.g., CMC) | 2 - 8 wt% |
| binder, resilient (e.g., SBR) | 8 - 15 wt% |
| solvent (e.g., water) | 20 - 30 wt% |

Electrolyte Paste

| | |
|---|---|
| conducting salt zinc chloride | 30 - 40 wt% |
| set-up agent (e.g., silicon oxide powder) | 2 - 4 wt% |
| mineral particles (e.g., CaCO₃) | 10 - 20 wt% |
| solvent (e.g., water) | 40 - 55 wt%. |

It is preferred for proportions of the individual components in the pastes respectively to add up to 100 wt%. The proportions of the nonvolatile components in the electrodes may be calculated from the corresponding percentage specifications of the pastes. For example, the proportions of zinc and the resilient binder in an anode produced from the paste above are 81.25 wt% to 92.94 wt% (zinc) and 5.62 wt% to 13.16 wt% (resilient binder). The proportions of manganese dioxide and the resilient binder in a cathode produced from the paste above are 61.72 wt% to 82.35 wt% (manganese dioxide) and 8.51 wt% to 20.83 wt% (resilient binder).

The electrolyte paste is preferably used in combination with a microporous polyolefin film (e.g., PE) with a thickness of 60 to 120 µm and a porosity of 35 - 60%. Preferably, according to the first or second particularly preferred alternative example above, layers of the electrolyte paste are formed on the electrodes and/or the separator, in particular with a thickness as specified, particularly preferably each with a thickness of about 50 µm. The anode is preferably printed as a layer with a thickness of 30 µm to 150 µm, in particular with a thickness of 70 µm . The cathode is preferably printed as a layer with a thickness of 180 to 350 µm, in particular with a thickness of 280 µm.

In another preferred example of the method, it is characterized by at least one of additional features and/or steps a. and b:
a. the first and the second electrical conductor or the first and the second electrical conductors are printed next to one another on the same carrier; and
b. a closed container, in which the layer stack is arranged, is formed by welding and/or adhesive bonding from the carrier after folding.

Particularly preferably, features a. and b. directly above are implemented in combination with one another.

As already mentioned, in our method, a layer stack having the sequence anode/separator/cathode is formed. This may preferably be done by printing the electrodes next to one another, that is to say in a coplanar arrangement, onto the carrier and folding the carrier such that the anode and the cathode as well as the separator arranged between them are superimposed. The carrier encloses the resulting layer stack on at least three sides after the folding. By welding and/or adhesive bonding of the remaining sides, a closed container can be formed. Adhesive bonding may in particular also be envisioned when the anode and the cathode have previously been surrounded with the aforementioned adhesive frame. In this example, the sealing frame may bring about the adhesive bonding.

Further features and advantages may be found in the following examples and the drawings, with the aid of which the batteries, tags and methods will be explained. The example described below serves merely for explanation and better understanding, and is in no way to be interpreted as restrictive.

### Example

(1) A current lead structure, including the first electrical conductor 105 and the second electrical conductor 106, is printed by screen printing onto a PET film 104 with a thickness of 200 µm. A commercially available conductive silver paste is used as the printing paste.
(2) In a further step, the current lead structure is covered with a thin coat of carbon particles. The coat of the carbon particles is preferably formed with a thickness of 12 µm. A typical carbon paste such as is used to form electrically conductive layers and connections in electronics is used as a printing paste.

To control the coverage of the current lead structure by the coat of the carbon particles, it may be preferable to subject the coat that has been formed to a heat treatment. The temperature which may be used in this example is dictated primarily by the thermal stability of the PET film, and must be selected accordingly.

Subsequently, to form an anode 101 and a cathode 102, the first electrical conductor 105 is printed over with a zinc paste and the second electrical conductor 106 is printed over with a manganese oxide paste. The pastes have the following compositions:

Zinc Paste

| | |
|---|---|
| zinc particles | 70 wt% |
| CMC | 2 wt% |
| SBR | 6 wt% |
| solvent (water) | 22 wt% |

Manganese Oxide Paste

| | |
|---|---|
| manganese oxide | 60 wt% |
| graphite | 6 wt% |
| zinc chloride | 2 wt% |
| CMC | 2 wt% |
| SBR | 5 wt% |
| solvent (water) | 25 wt%. |

The anode 101 and the cathode 102 each occupy an area of 20 cm² on the PET film 104. The anode is preferably formed as a layer with a thickness of 70 µm. The cathode is preferably formed as a layer with a thickness of 280 µm. More than one printing process may be needed for the formation of the cathode layer.

In a subsequent step, the anode 101 is covered with a separator 103. For example, a commercially available nonwoven separator or a microporous polyolefin film may be used as the separator 103. Preferably, a microporous polyolefin film which has a thickness of 60 - 120 µm and a porosity (ratio of the hollow volume to total volume) of 35 - 60% is used.

In another subsequent step, the anode 101 and the cathode 102 as well as the separator 103 are printed on with an aqueous zinc chloride solution, after a sealing frame 107 that encloses the anode 101 and the cathode 102, has been formed on the PET film 104 by an adhesive compound. For example, a commercially available solder resist may be used as the starting material for the formation of the sealing frame 107.

It has proven particularly advantageous to print a first layer of a highly viscous aqueous zinc chloride solution (electrolyte paste) onto one of the electrodes, particularly in a thickness of about 50 µm, to apply the separator onto this first layer, and print on the separator with a second layer of the electrolyte paste, likewise with a thickness of about 50 µm. The sealing frame 107 is preferably formed already before the printing of the first layer (variant 1).

It has likewise proven advantageous to print a first layer of an electrolyte paste onto the anode, particularly in a thickness of about 50 µm, to print a second layer of an electrolyte paste onto the cathode, particularly in a thickness of about 50 µm, and to apply the separator onto one of these layers. The sealing frame 107 is preferably formed already before the printing of the first and second layers (variant 2).

As a result (although in the second example only after step (6)), a layer of the electrolyte is then arranged on both sides of the separator. Preferably, an electrolyte paste having the following composition is used:

| | |
|---|---|
| zinc chloride | 35 wt% |
| set-up agent (silicon dioxide) | 3 wt% |
| water-insoluble mineral particles | 15 wt% |
| solvent (water) | 47 wt%. |

Finally, the PET film 104 is folded along a crease line 104a so that the anode 101 and the cathode 102 as well as the separator 103 arranged between them form a layer stack 108. Together with the PET film 104, the sealing frame 107 forms a closed housing 109.

Besides the battery 100, the RFID tag 110 represented in FIG. 3 comprises a transmission and/or reception unit 111 that transmits and/or receives radio signals, a sensor system 113 and an antenna 112 coupled to the transmission and/or reception unit 110. The components of the RFID tag are connected to one another by a conductor structure. An adhesive layer (not represented), by which the RFID tag 110 can be fixed on a product, may be arranged on the lower side of the tag 110.

The battery 100 may particularly preferably comprise four layer stacks electrically connected in series, each with a rated voltage of 1.5 volts. It is therefore capable of providing a rated voltage of 6 volts.

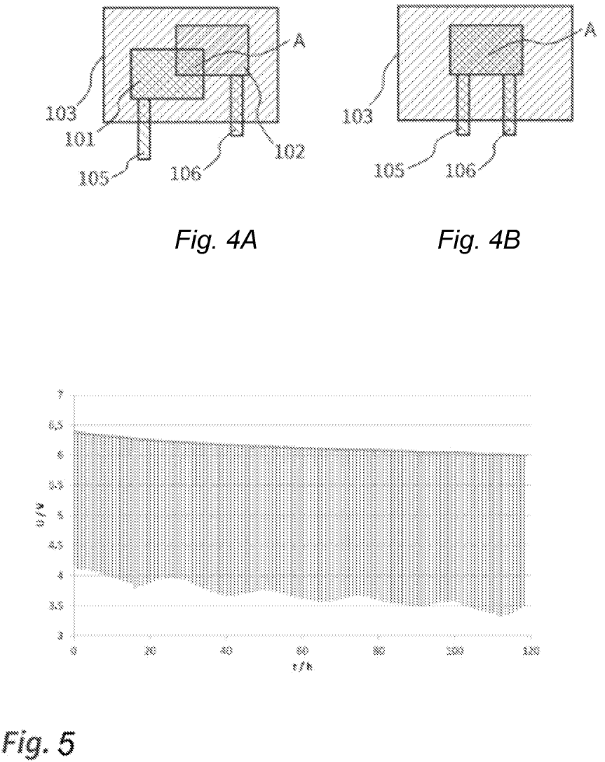

FIGS. 4A and 4B represent examples of a layer stack in which a separator 103, configured as a layer, is arranged between the anode 101 configured as a layer and the cathode 102 configured as a layer. The anode 101 and the cathode 102 are each configured rectangularly and each cover the same area of the separator 103. In the drawing, all the layers are arranged parallel to the plane of the drawing. The area of the separator 103 which is covered by the anode 101 is defined in the present description as a first contact face. The area of the separator 103 which is covered by the cathode 102 is defined in the present description as a second contact face.

In FIG. 4A, the anode 101 and the cathode 102 are arranged offset with respect to one another so that the first and the second contact faces only partially overlap one another in a viewing direction perpendicular to the plane of the drawing, and therefore perpendicular to the separator 103. The overlap region A is therefore smaller than the areas which the anode 101 and the cathode 102 cover on the separator 103.

In FIG. 4B, on the other hand, the anode 101 and the cathode 102 overlap fully. The size of the overlap region A therefore corresponds exactly to the area of the anode 101 and of the cathode 102.

Full overlap of the electrodes, as represented in FIG. 4B, is advantageous with a view to a high current carrying capacity.

The results of a pulse test represented in FIG. 5 were obtained with a battery comprised of four layer stacks produced according to the example (production of the electrolyte layer according to variant 2 with the preferred electrolyte paste). The overlap regions of the four layer stacks were each 22 cm². The layer stacks were electrically connected in series and delivered a rated voltage of 6 V. In fact, the open-circuit voltage was about 6.4 volts, and the end-of-discharge voltage was about 3.1 volts. Before the measurement, the battery was stored for a period of one month at 45° to artificially simulate aging. The battery nevertheless delivered a total of 118 TX pulses. In a loading test, a fresh battery delivered more than 400 TX pulses and is therefore outstandingly suitable for the current supply of an LTE chip.

1-15. (canceled)

16. A printed battery that supplies a transmission and/or reception unit of an RFID tag with an electrical current of at peak ≥ 400 mA, comprising:
a. a layer stack having
an anode configured as a layer that contains particulate metallic zinc or a particulate metallic zinc alloy as an active electrode material and a first resilient binder or binder mixture, and
a cathode configured as a layer that contains a particulate metal oxide as an active electrode material, at least one conductivity additive to control the electrical conductivity of the cathode, and a second resilient binder or binder mixture, and
a separator configured as a layer that electrically insulates the anode and the cathode from one another,
b. a first electrical conductor in direct contact with the anode, and a second electrical conductor in direct contact with the cathode, and
c. a housing that encloses the layer stack,
wherein
d. the separator is arranged between the anode and the cathode and comprises a first side and a second side, of which the first side comprises a first contact face for the anode and the second side parallel thereto comprises a second contact face for the cathode, and
e. the contact faces overlap one another, in a viewing direction perpendicular to the separator configured as a layer, in an overlap region A in which a straight line perpendicular to the separator intersects the two contact faces,
f. the cathode contains the particulate metal oxide in a proportion of 10 wt% to 90 wt%, expressed in terms of the total weight of the solid constituents of the cathode (102),
g. the cathode contains the second resilient binder or binder mixture in a proportion of 1 wt% to 25 wt%, expressed in terms of the total weight of the solid constituents of the cathode,
h. the cathode contains the at least one conductivity additive in a proportion of 2.5 wt% to 35 wt%, expressed in terms of the total weight of the solid constituents of the cathode, and i. an overlap region A of the battery has a minimum size of 17.3 cm².

17. The printed battery as claimed in claim 16, having at least one of:
a. a first layer stack having features a. and d. to h.;
b. a second layer stack having features a. and d. to h.;
c. optionally, n further layer stacks having features a. and d. to h., where n is preferably an integer between 1 and 100;
d. each of the layer stacks has an overlap region with a minimum size of 17.3 cm², and
e. the layer stacks of the battery are interconnected with one another electrically in series and/or electrically in parallel.

18. The printed battery as claimed in claim 16, wherein:
a. the cathode contains at least one carbon-based material as a conductivity additive selected from the group consisting of activated carbon, activated carbon fibers, carbide-derived carbon, carbon aerogel, graphite, graphene and carbon nanotubes (CNTs); and
b. the cathode contains the at least one carbon-based material in a proportion of 2.5 wt% to 35 wt%.

19. The printed battery as claimed in claim 16, wherein:
a. the cathode contains at least one water-soluble salt as a conductivity additive; and
b. the cathode contains the at least one water-soluble salt in a proportion of 1 wt% to 25 wt%.

20. The printed battery as claimed in claim 16, wherein one of:
a. the cathode contains manganese oxide as a particulate metal oxide; and
b. the cathode contains silver oxide as a particulate metal oxide.

21. The printed battery as claimed in claim 16, wherein at least one of:
a. the anode contains as a first resilient binder or binder mixture at least one member of the group consisting of cellulose and derivatives thereof, polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR) and mixtures of the aforementioned materials;
b. the cathode contains as a second resilient binder or binder mixture at least one member of the group consisting of cellulose and derivatives thereof, polyacrylates (PA), polyacrylic acid (PAA), polychlorotrifluoroethylene (PCTFE), polyhexafluoropropylene (PHFP), polyimides (PI), polytetrafluoroethylene (PTFE), polytrifluoroethylene (PTrFE), polyvinyl alcohol (PVA), polyvinylidene difluoride (PVDF), styrene-butadiene rubber (SBR) and mixtures of the aforementioned materials; and
c. the first and the second resilient binder or binder mixture are materially identical.

22. The printed battery as claimed in claim 20, wherein:
a. the cathode contains a metal oxide from the group consisting of manganese oxide and silver oxide as a particulate metal oxide;
b. the cathode contains at least one water-soluble salt as a conductivity additive;
c. the cathode contains the at least one water-soluble salt in a proportion of 1 wt% to 25 wt%; and
d. the cathode contains a combination of carboxymethyl cellulose and SBR as a second resilient binder or binder mixture.

23. The printed battery as claimed in claim 16, further comprising at least one of:
a. an aqueous electrolyte that contains a chloride-based conducting salt; and
b. the separator arranged between the anode and the cathode is impregnated with the electrolyte.

24. The printed battery as claimed in claim 16, wherein:
a. the separator is a solid electrolyte.

25. The printed battery as claimed in claim 16, further comprising:
a. a conductive track consisting of metal particles or silver particles or particles of a silver alloy, as a first and/or second electrical conductor.

26. An RFID tag comprising, on a carrier, a transmission and/or reception unit that transmits and/or receives radio signals and a printed battery arranged on the carrier that supplies the transmission and/or reception unit with an electrical current of at peak ≥ 400 mA, wherein the battery is configured as claimed in claim 16.

27. A method of producing a printed battery that supplies a transmission and/or reception unit of an RFID tag with an electrical current of at peak ≥ 400 mA, comprising:
a. printing a first electrical conductor onto an electrically nonconductive carrier and a second electrical conductor onto an electrically nonconductive carrier;
b. printing an anode as a layer directly onto the first electrical conductor, a printing paste that contains particulate metallic zinc or a particulate metallic zinc alloy and a first resilient binder or binder mixture being used;
c. printing a cathode as a layer directly onto the second electrical conductor, a printing paste that contains a particulate metal oxide, at least one conductivity additive for optimizing the electrical conductivity of the cathode and a second resilient binder or binder mixture being used, wherein
the printing paste contains the particulate metal oxide in a proportion of 10 wt% to 90 wt%, expressed in terms of the total weight of its solid constituents;
the printing paste contains the second resilient binder or binder mixture in a proportion of 1 wt% to 15 wt%, expressed in terms of the total weight of its solid constituents; and
the printing paste contains the at least one conductivity additive in a proportion of 2.5 wt% to 35 wt%, expressed in terms of the total weight of its solid constituents;
d. printing or applying a separator, configured as a layer, onto the anode and/or the cathode; and
e. forming a layer stack consisting of the sequence anode/separator/cathode, in which
the separator is arranged between the anode and the cathode and comprises a first side and a second side, of which the first side comprises a first contact face for the anode and the second side parallel thereto comprises a second contact face for the cathode;
the contact faces overlap one another, in a viewing direction perpendicular to the separator configured as a layer, in an overlap region A in which a straight line perpendicular to the separator intersects the two contact faces; and
the overlap region A has a minimum size of 17.3 cm².

28. The method as claimed in claim 27, wherein:
a. manganese oxide is used as particulate metal oxide; and
b. the first and/or the second conductor are printed over with an electrically conductive carbon layer before the anode and the cathode are printed.

29. The method as claimed in claim 27, wherein at least one of:
a. before and/or after the printing or applying of the separator configured as a layer, the anode and the cathode are impregnated with a liquid electrolyte; and
b. before the impregnation with the liquid electrolyte, a sealing frame that encloses the anode and the cathode is formed or arranged on the carrier.

30. The method as claimed in claim 27, wherein:
a. the first and the second electrical conductor are printed next to one another on the same carrier; and
b. a closed container, in which the layer stack is arranged, is formed from the carrier by welding and/or adhesive bonding after folding.
